(19) United States
(12) Patent Application Publication
(10) Pub. No.: US 2025/0025814 A1
(43) Pub. Date: Jan. 23, 2025

(54) INTERNAL PERFORMANCE MONITORING FOR WATER FILTER

(71) Applicant: Haier US Appliance Solutions, Inc., Wilmington, DE (US)

(72) Inventors: Amin Firouzi, Louisville, KY (US); Gregory Sergeevich Chernov, Louisville, KY (US)

(21) Appl. No.: 18/355,919

(22) Filed: Jul. 20, 2023

(51) Int. Cl. B01D 35/143; B01D 29/15; B01D 29/60; B01D 35/06; B01D 37/04; B01D 39/20; C02F 1/00

(52) U.S. Cl. CPC B01D 35/1435; B01D 29/15; B01D 29/60; B01D 35/06; B01D 37/04; B01D 39/2055; C02F 1/003; C02F 1/008; B01D 2239/0435; C02F 2209/05; C02F 2209/445; C02F 2307/12; F25D 2323/121

(57) ABSTRACT

A water filter assembly with a sensing system coupled to an electrode in a feed water chamber and an electrode in a treated water chamber. A controller receives signals from the feed water and treated water electrodes that are proportional to a water quality parameter in the feed water chamber and the treated water chamber and determines a filter status based on the signals.

### FIELD OF THE INVENTION

The present disclosure relates generally to water filters for household appliances, in particular for performance monitoring for water filters in household appliances.

### BACKGROUND OF THE INVENTION

Many known household appliances include water filters to remove particulates, dissolved solids, tastes, odors, or other undesirable contaminants of a water supply. Typically, the water filters include consumable filter elements that are replaced at the end of a period of use. Commonly, the useful life of the filter element is determined by the filter's time in service or the volume of water that has been filtered. However, neither determination of the useful life measures the effectiveness of the filter in removing contaminants from the water supply.

Water supplies vary in the level of contaminants present. In some cases, a water supply may have a relatively low level of contamination while other water supplies may have a relatively higher concentration of contaminants. Service life predictors, using either time in service or volume of water filtered, would predict the same useful life of the filter element regardless of the effectiveness of the filter element at the prescribed time or after the prescribed volume filtered. In the case of a water supply with a low contaminant level, the filter element may reach the end of its predicted service life while the element may still have useful life remaining. In the case of a water supply with a higher level of contaminants, the predicted life of the filter element may exceed its useful life.

Accordingly, a water filter with internal performance monitoring may be desirable to more accurately determine the useful life of a water filter element.

### BRIEF DESCRIPTION OF THE INVENTION

Aspects and advantages of the invention will be set forth in part in the following description, may be apparent from the description, or may be learned through practice of the invention.

In one exemplary aspect, a water filter assembly for a host appliance is provided. The water filter comprises a filter housing defining a filter chamber, a feed water inlet, and a treated water outlet. A filter element is received within the filter chamber defining a feed water chamber and a treated water chamber. A feed water electrode is disposed in the feed water chamber, a treated water electrode is disposed in the treated water chamber, and a common electrode is in electrical communication with the feed water chamber and the treated water chamber. An electric power supply is in electrical communication with the feed water electrode, the treated water electrode, and the common electrode, and a sensing system is electrically coupled to the feed water electrode, the treated water electrode, and the common electrode. A controller electrically coupled to the electric power supply and the sensing system. The controller is configured to receive a first signal from sensing system that is proportional to a water quality parameter of a content of the feed water chamber, receive a second signal from the sensing system that is proportional to a water quality parameter of a content of the treated water chamber, and determine a filter status based on the first and second signals.

In another exemplary aspect, a method of operating a water filter assembly is provided. The filter assembly comprises a filter housing defining a filter chamber, a filter element received within the filter chamber defining a feed water chamber and a treated water chamber. Further, a feed water electrode is disposed in the feed water chamber, a treated water electrode is disposed in the treated water chamber, and a common electrode is in electrical communication with the feed water chamber and the treated water chamber. An electric power supply is in electrical communication with the feed water electrode, the treated water electrode, and the common electrode. A sensing system comprising a first electrical measurement device is electrically coupled to the feed water electrode and the common electrode and a second electrical measurement device is electrically coupled to the treated water electrode and the common electrode, and a controller is electrically coupled to the electric power supply and the sensing system. The method comprises receiving at the controller a first signal from the first electrical measurement device that is proportional to a water quality parameter of a content of the feed water chamber and receiving at the controller a second signal from the second electrical measurement device that is proportional to a water quality parameter of a content of the treated water chamber. Determining a conductivity of the content of the feed water chamber and determining a conductivity of the content of the treated water chamber. Determining a status of the filter element based on the determined conductivity of the content of the feed water chamber and the determined conductivity of the content of the treated water chamber, and displaying a status of the filter element on a display.

In another exemplary aspect, a water filter assembly for a host appliance is provided. The water filter assembly comprises a filter housing defining a filter chamber, a feed water inlet, and a treated water outlet. A filter element is received within the filter chamber defining a feed water chamber and a treated water chamber. A feed water sensor array is disposed in the feed water chamber, and a treated water sensor array comprising is disposed in the treated water chamber. An electric power supply is in electrical communication with the feed water electrodes and the treated water electrodes. A sensing system is electrically coupled to the feed water electrodes and the treated water electrodes, and a controller is electrically coupled to the electric power supply and the sensing system. The controller is configured to receive a first signal from the sensing system that is proportional to a water quality parameter of a content of the feed water chamber, receive a second signal from the sensing system that is proportional to a water quality parameter of a content of the treated water chamber, and determine a filter status based on the first and second signals.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water filter assembly in accordance with an embodiment of the present disclosure;

FIG. 2 presents an exploded view of the assembly of FIG. 1;

FIG. 3 presents a partial sectional view of the assembly of FIG. 1 taken along III-III of FIG. 1;

FIG. 4 presents an enlarged view of a portion of the filter assembly of FIG. 3 taken at IV-IV in accordance with an embodiment of the present disclosure;

FIG. 5 is an axial view of the filter assembly of FIG. 4;

FIG. 6 presents an enlarged view of a portion of the filter assembly of FIG. 3 taken at IV-IV in accordance with an embodiment of the present disclosure;

FIG. 7 is an axial view of the filter assembly of FIG. 6;

FIG. 8 presents an enlarged view of a portion of the filter assembly of FIG. 3 taken at IV-IV in accordance with an embodiment of the present disclosure;

FIG. 9 is an axial view of the filter assembly of FIG. 8; and

FIG. 10 illustrates a method for operating a water filter assembly in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

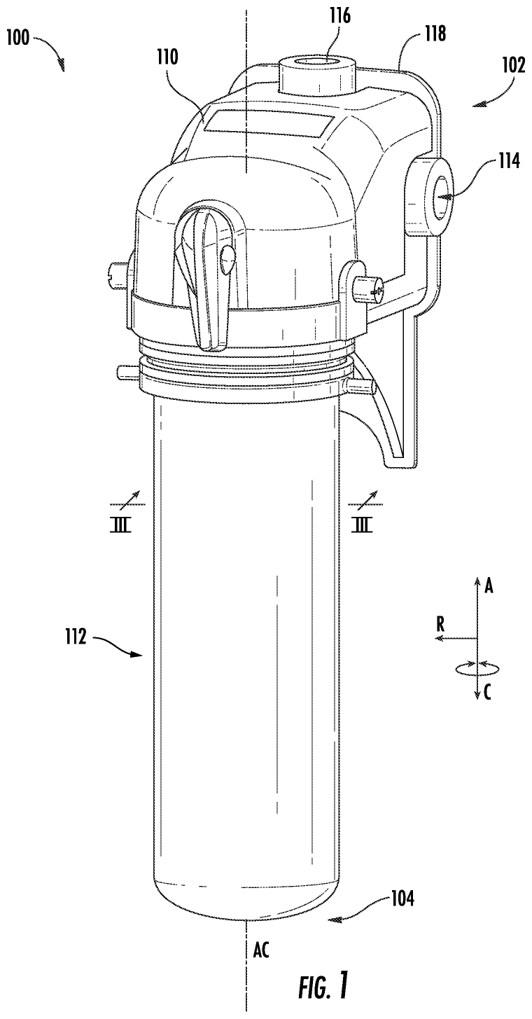

Turning to the figures, FIG. 1 provides a perspective view of a water filter assembly 100 in accordance with an embodiment of the present disclosure. Filter assembly 100 defines an axial direction A, a radial direction R extending outward from the axial direction A, and a circumferential direction C extending about axial direction A (e.g., three hundred sixty degrees) (360° about the axial direction A). In addition, an axial centerline AC is defined by filter assembly 100 as shown in FIG. 1. As used herein, “radially inward” is a direction toward the axial centerline AC and “radially outward” is a direction opposite or away from the axial centerline AC.

Filter assembly 100 may be used with potable water provided by, for example, a private well or a municipal water supply. Removal of undesired components (e.g., sediment, chemicals, microorganisms) from the liquid may be accomplished, for example, by combinations of mechanical filtration, adsorption, or other processes. The various embodiments of the present disclosure will be described with reference to the filtration of potable water. However, the exemplary embodiments described and illustrated herein may be used for filtering other liquids as well. For potable water, filter assembly 100 may be installed near the point of entry of the water supply into a home or a commercial structure. Thus, in some embodiments, filter assembly 100 is a point of entry filter assembly. Alternatively, filter assembly 100 may be installed in a host appliance, for example a refrigerator, for providing filtered water through a distribution system in the refrigerator. Other installations may be used as well. Thus, in some embodiments, filter assembly 100 is a point of use filter assembly.

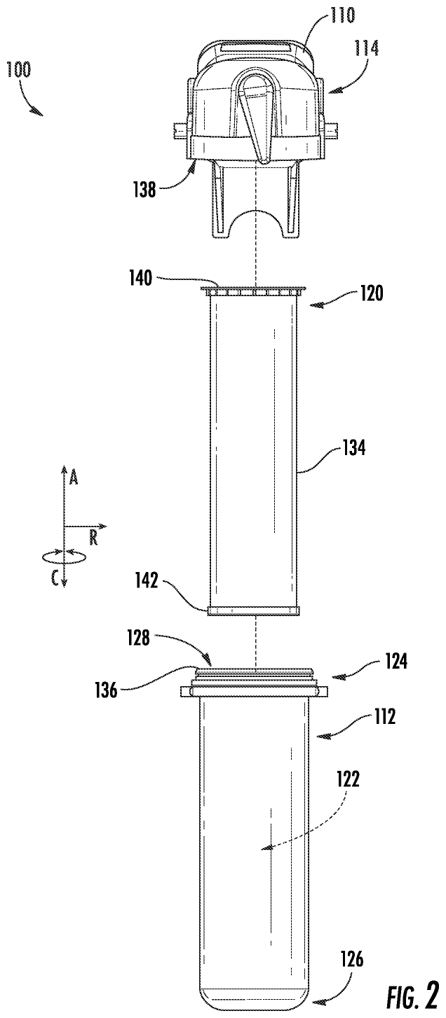

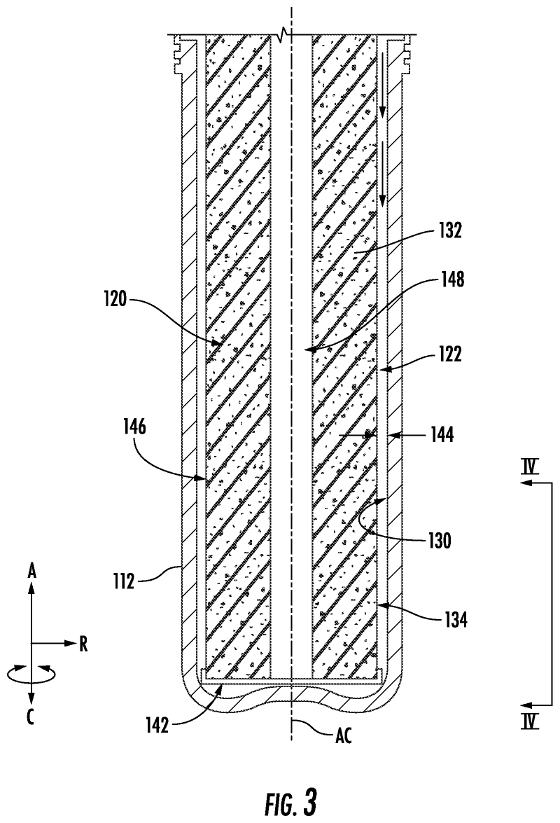

As depicted, filter assembly 100 extends between a top 102 and a bottom 104 along the axial direction A. Generally, filter assembly 100 includes a manifold 110 positioned at or proximate top 102 of filter assembly 100, a housing 112 removably mounted to manifold 110, and a filter element 120 (FIG. 2) removably received within housing 112 for filtering fluid. As shown particularly in FIG. 3, when filter assembly 100 is assembled, filter element 120 is disposed or received within an internal chamber 122 defined by housing 112.

Manifold 110 has an inlet 114 for receiving a fluid flow into filter assembly 100. Inlet 114 may be in fluid communication with a water supply and may receive unfiltered water from the water supply. Internal features of manifold 110, filter element 120, and housing 112 direct or route the unfiltered water into a filter media 132 of filter element 120 for filtering the water. The filtered water then travels out of filter assembly 100 through an outlet 116 of manifold 110. The filtered water may then be distributed within a host appliance, for example to a refrigerator appliance, etc. Further, manifold 110 includes a mounting bracket 118 that provides a structural component for mounting of filter assembly 100 to a suitable structure on a host appliance. Other configurations for mounting or hanging filter assembly 100 may be used as well.

As depicted in FIG. 2, housing 112 extends between a top portion 124 and a bottom portion 126, e.g., along the axial direction A. Housing 112 also defines an opening 128 at its top portion 124. Opening 128 permits access to internal filter chamber 122 of housing 112. As noted above, housing 112 is removably mounted to manifold 110. For instance, for this exemplary embodiment, housing 112 includes threads 136 that are complementary to threads 138 of manifold 110 such that housing 112 is removably mounted to manifold 110 by a threaded engagement between threads 136 of housing 112 and threads 138 of manifold 110. In this way, housing 112 may be removed to access filter element 120, e.g., to inspect or replace filter element 120. Housing 112 may be removably mounted to manifold 110 in other suitable manners as well. Housing 112 may be formed of any suitable material and in any suitable manner. For example, housing 112 may be molded from a suitable plastic material, or alternatively, housing 112 may be cast from aluminum or stainless steel.

Referring particularly to FIG. 2, filter element 120 extends between a top portion 140 and a bottom portion 142 along the axial direction A as shown. Filter media 132 is disposed between the top portion 140 of the filter element 120 and the bottom portion 142. Filter media 132 may be constructed from a variety of materials. For instance, filter media 132 may be an activated carbon block, pleated sheets, melt-blown polypropylene, string wound filters, paper, various textiles, adsorption media, a combination thereof, or other suitable materials depending upon the filtration desired. For purposes of this disclosure, filter media 132 comprises an activated carbon in a block form or may be carbon granules (i.e., granulated carbon) or powder compressed with a binder. In some embodiments, the filter media 132 may be electrically conductive, in particular in embodiments including a form of carbon in the filter media 132.

As depicted in FIG. 1, manifold 110 defines one or more inlet passages 114 (one inlet passage 114 is show) and an outlet passage 116. For this embodiment, outlet passage 116 is a single outlet passage (i.e., the only outlet through which fluid may flow out of filter element 120 and housing 112). Inlet passage 114 is in fluid communication with internal chamber 122 of housing 112.

FIG. 3 represents the filter assembly of FIG. 1 with the manifold 110 removed for clarity. As shown in FIG. 3, filter element 120 is disposed or received within internal chamber 122 when filter assembly 100 is assembled. Filter media 132 of filter element 120 is spaced apart from an inner surface 130 of housing 112, e.g., along the radial direction R. Filter element 120 is removably received in housing 112 and, when assembly 100 is fully assembled, top portion 140 is mounted directly to manifold 110. The mounting of filter element 120 to manifold 110 secures filter media 132 in place in order to define a gap 144 between inner surface 130 of housing 112 and an outer surface 134 of the filter element 120.

Filter element 120 divides internal chamber 122 into two defined areas, a feed water chamber 146 and a filtered water chamber 148. Generally, feed water chamber 146 extends about filter element 120 along the circumferential direction C. between top portion 124 and bottom portion 126 of housing 112 along the axial direction A, and between inner surface 130 of housing 112 and outer surface 134 of filter element 120 along the radial direction R. Outer surface 134 of filter element 120 defines a filter media inlet through which unfiltered liquid flows to treated water chamber 148. Treated water chamber 148 is defined by filter element 120 as a generally cylindrical volume that extends along the axial direction A, and more particularly, along the axial centerline AC. Filter media 132 removes impurities and contaminants from water passing through filter media 132 from feed water chamber 146 to treated water chamber 148. As used herein, the term “feed water” describes a volume within internal chamber 122 that is not filtered relative to filter element 120. However, as will be understood by those skilled in the art, additional filter assemblies may filter the water prior to entering internal chamber 122 of filter assembly 100. Thus, “feed water” may be filtered relative to other filters but not filter element 120.

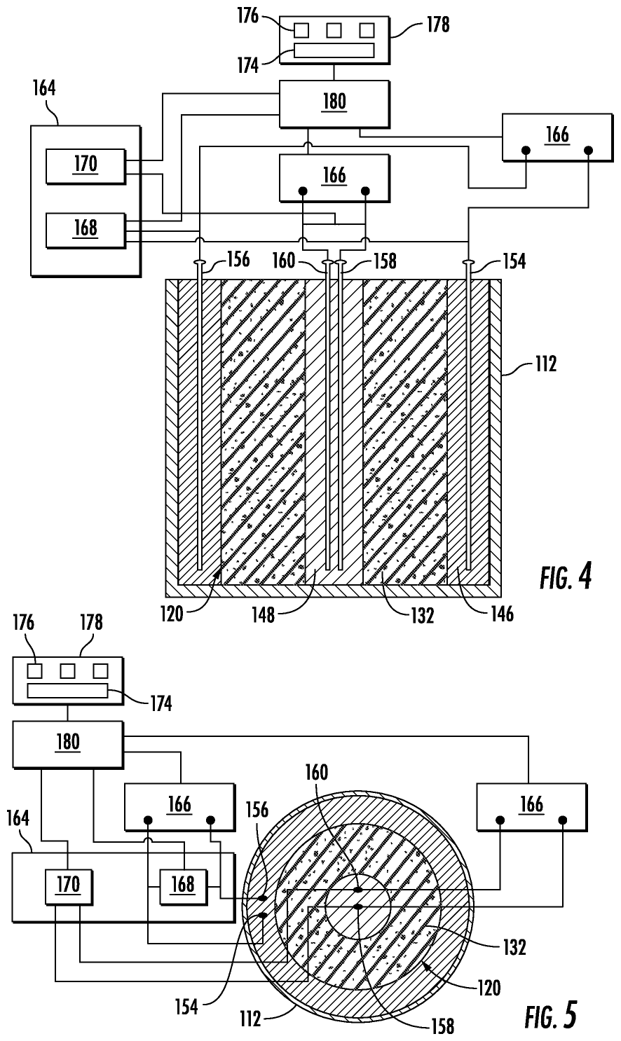

FIGS. 4, 6, and 8 represent enlarged and simplified illustrations of a portion of the filter assembly of FIG. 3 taken along IV-IV. FIGS. 5, 7, and 9 represent simplified axial views of FIGS. 4, 6, and 8, respectively. According to embodiments of the present disclosure, water filter assembly 100 includes a first feed water electrode 154 disposed in the feed water chamber 146 and a first treated water electrode 158 disposed in the treated water chamber 148. The electrodes 154, 158 may be formed from any conductive material, such as metal, conductive polymers, or carbon. The electrodes 154, 158 may extend from the top portion 124 of the housing 112 axially downward towards the bottom portion 126 as illustrated. In other embodiments, the electrodes 154, 158 may extend from the bottom portion 126 axially upward towards the top portion 124. In still other embodiments, the electrodes 154, 158 may be circular with the feed water electrode 154 encircling the filter element 120 and the first treated water electrode 158 may encircle the axial centerline AC. In some embodiments, the electrode arrangement may include one or more of the illustrated configurations.

As illustrated for example in FIG. 4, embodiments of the present disclosure may include a second feed water electrode 156 disposed in the feed water chamber 146 and a second treated water electrode 160 disposed in the treated water chamber 148. First and second feed water electrodes 154, 156 form a feed water sensor array and first and second treated water electrodes 158, 160 form a treated water sensor array. As illustrated, the first and second feed water electrodes 154, 156 and the first and second treated water electrodes 158, 160 may be in electrical communication with an electric power supply 166. In embodiments, the feed water electrodes 154, 156 may have a power supply separate from the power supply 166 for treated water electrodes 158, 160 as illustrated. In other embodiments, one power supply 166 may be provided with multiple terminals for providing electrical power to the electrodes.

According to some embodiments, the power source 166 may provide an electrical voltage to the electrodes. For example, power supply 166 may provide a first voltage to the feed water electrodes 154, 156 and a second voltage to the treated water electrodes 158, 160. The first voltage (to feed water electrodes 154, 156) may be the same as or different than the voltage provided to the treated water electrodes 158, 160. The voltages may differ in magnitude or frequency, or in both magnitude and frequency.

A sensing system 164 (FIGS. 4 and 5) including a first electrical sensor 168 may be electrically coupled to the first and second feed water electrodes 154, 156 and a second electrical sensor 170 may be electrically coupled to the first and second treated water electrodes 158, 160. First and second electrical sensors 168, 170 may be included in one sensing or measurement system provided to sense and measure electrical signals generated within the feed water and treated water chambers 146, 148. For example, first and second electrical sensors 168, 170 of sensing system 164 may be two separate and distinct outputs from the same device. Accordingly, sensing system 164 may comprise one electrical measurement device configured to sense and report two distinct electrical signals. In other embodiments, first and second electrical sensors 168, 170 may be components of separate devices.

When electric power supplies 166 provide the first and second feed water electrodes 154, 156 and the treated water electrodes 158, 160 with a voltage, the sensing or measurement system, more particularly the electric measurement sensors 168, 170, may be configured to provide a reading of a current. For example, when a voltage is applied to first and second feed water electrodes 154, 156, a content in the feed water chamber 146, for example feed water, completes an electric circuit and allows a current to flow between the first and second feed water electrodes 154, 156. First electrical detection and measurement sensor 168 may be an ammeter electrically coupled to the feed water electrodes 154, 156 and configured to sense the current developed.

To facilitate the control of the power supply 166 and the electrical measurement sensors 168, 170, water filter assembly 100 may be in communication with a control panel 178 that may represent a general-purpose Input/Output (“GPIO”) device or functional block for water filter assembly 100. In some embodiments, control panel 178 may include or be in operative communication with one or more user input devices 176, such as one or more of a variety of digital, analog, electrical, mechanical, or electro-mechanical input devices including rotary dials, control knobs, push buttons, toggle switches, selector switches, and touch pads. Additionally, water filter assembly 100 may include a display 174, such as a digital or analog display device generally configured to provide visual feedback regarding the operation of water filter assembly 100. For example, display 174 may be provided on control panel 178 and may include one or more status lights, screens, or visible indicators to communicate the remaining useful life of the filter assembly 100. According to exemplary embodiments, user input devices 176 and display 174 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Water filter assembly 100 may further include or be in operative communication with a processing device or a controller 180 that may be generally configured to facilitate appliance operation. In this regard, control panel 178, user input devices 176, and display 174 may be in communication with controller 180 such that controller 180 may receive control inputs from user input devices 176, may display information using display 174, and may otherwise regulate operation of water filter assembly 100. For example, signals generated by controller 180 may operate water filter assembly 100, including any or all system components, subsystems, or interconnected devices, in response to the position of user input devices 176 and other control commands. Control panel 178 and other components of water filter assembly 100 may be in communication with controller 180 via, for example, one or more signal lines or shared communication busses. In this manner, Input/Output (“I/O”) signals may be routed between controller 180 and various operational components of water filter assembly 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 180 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 180 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 180 may be operable to execute programming instructions or micro-control code associated with an operating cycle of water filter assembly 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 180 as disclosed herein is capable of and may be operable to perform any methods, method steps, or portions of methods as disclosed herein. For example, in some embodiments, methods disclosed herein may be embodied in programming instructions stored in the memory and executed by controller 180.

The memory devices may also store data that can be retrieved, manipulated, created, or stored by the one or more processors or portions of controller 180. The data can include, for instance, data to facilitate performance of methods described herein. The data can be stored locally (e.g., on controller 180) in one or more databases and/or may be split up so that the data is stored in multiple locations. In addition, or alternatively, the one or more database(s) can be connected to controller 180 through any suitable network(s), such as through a high bandwidth local area network (LAN) or wide area network (WAN). In this regard, for example, controller 180 may further include a communication module or interface that may be used to communicate with one or more other component(s) of water filter assembly 100, controller 180, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

For example, the controller 180 may control the electrical power supply 166 to provide a known controlled and consistent voltage to the feed water electrodes 154,156 and receive electrical data in the form of an electrical signal from the measurement and sensor device 168. From that information, the controller 180, or a processor within the controller 180, can execute a set of instructions to determine the conductivity of the content of the feed water chamber 146.

The controller 180 may also instruct the electric power supply 166 to provide a known controlled and consistent voltage to the first treated water electrode 158. Similar to the feed water side, the content of the treated water chamber 148 completes the circuit and a current develops that is detectable by second electrical measurement sensor 170. The second electrical measurement sensor 170, electrically coupled to the controller 180, communicates an electrical signal representative of the detected current developed in the treated water chamber 148, to the controller 180. From that information, the controller 180, or a processor within the controller 180, can execute a set of instructions to determine the conductivity of the content of the treated water chamber 148.

The resistivities of the contents of the feed water chamber 146 and the treated water chamber 148 are directly proportional to a water quality parameter, namely the amount of dissolved solids, and in particular metals and ionic compounds. At the controller 180, the resistivities of the contents of the two chambers 146, 148 can be mathematically manipulated and used to determine the status of the filter element 120. That is, if the difference between the feed water conductivity and the treated water conductivity is greater than a predetermined value, the controller 180 can determine that the filter element 120 is functioning and removing unwanted contaminants. From the status, the controller 180 may be able to estimate the remaining useful life of the filter based on previous performance. Similarly, if the difference in resistivities is below a predetermined value, the controller 180 determines the status of the filter element 120 is “filter failure” and can provide an appropriate signal, for example through the display 174 on the control panel 178.

In some embodiments, the power source 166 may provide an electrical current to the electrodes, for example to first and second feed water electrodes 154, 156. As above, the controller 180 drives the power supply 166 to provide a consistent current to the electrodes 154, 156. The content of the feed water chamber 146 completes the circuit and the current induces a voltage difference between the electrodes 154, 156. First electrical measurement sensor 168, electrically coupled to electrodes 154, 156 may be a voltmeter configured to sense a voltage.

As with the provided voltage, the provided current, and the resulting induced voltage, can be processed at the controller to determine the conductivity of the contents of the feed water chamber 146. Through a similar arrangement, the conductivity of the content of the treated water chamber 148 may also be determined by the controller 180. As discussed above, with the determined resistivities of the contents of the feed water chamber 146 and treated water chamber 148, the status of the filter element 120 can be determined. The determined resistivities can be mathematically manipulated and used to determine the status of the filter element 120. That is, if the difference between the feed water conductivity and the treated water conductivity (i.e., the determined conductivities of feed water and treated water) is greater than a predetermined value, the controller 180 can determine that the filter element 120 is functioning and removing unwanted contaminants. The controller 180 may cause a display indicating the status (e.g., a remaining useful life) on display 174 at the control panel 178. From the status, the controller may calculate or estimate a remaining useful life. Similarly, if the difference in resistivities is below a predetermined value, the controller 180 determines the status of the filter element 120 is “filter failure” and can provide an appropriate signal, for example through the display 174 on the control panel 178.

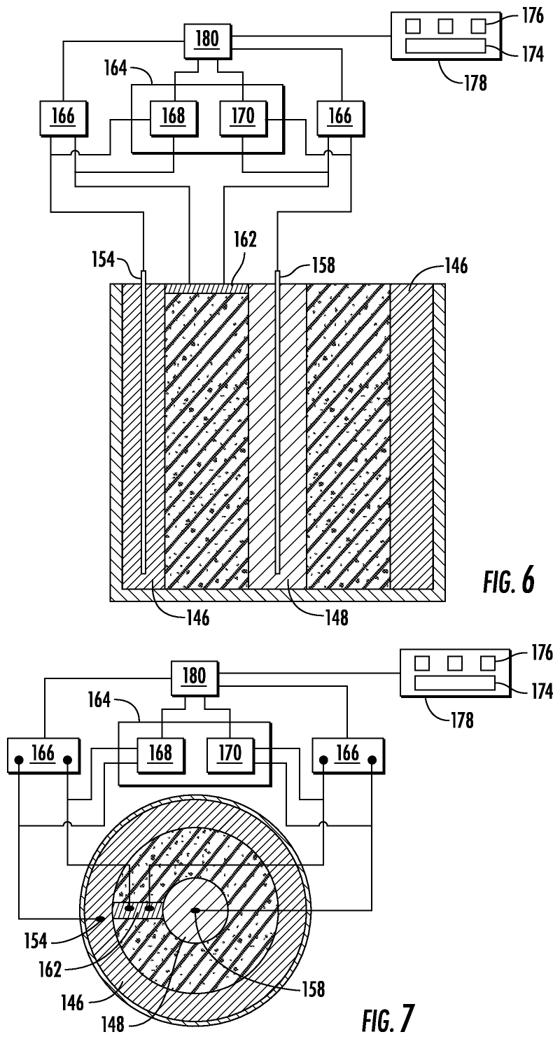

FIGS. 6 and 7 are illustrative of an embodiment in accordance with the present disclosure. As illustrated, first feed water electrode 154 is disposed in the feed water chamber 146 and first treated water electrode 158 is disposed in the treated water chamber 148. Second feed water electrode 156 and second treated water electrode 160 share a common electrode 162. The common electrode 162 is in electrical communication with the feed water chamber 146 and the treated water chamber 148. The common electrode 162 may rest at the top portion of the filter element 120, for example on the top surface of the filter media 132 or may be embedded in the filler media 132.

The electric power supply 166 is in electrical communication with the feed water electrode 154, the treated water electrode 148 and the common electrode 162. The sensing system includes the first electrical measurement sensor 168 electrically coupled to the first feed water electrode 154 and the common electrode 162. The second electrical measurement device is electrically coupled to the first treated water electrode 158 and the common electrode 162.

As in other embodiments, controller 180 drives the power supply 166 to provide a controlled and consistent voltage (or current), the first and second electrical measurement devices detect the resulting current (or voltage) and communicates the data to the controller 180. From the known controlled voltage (or current) and the detected current (or voltage), the controller 180 processes the electrical information and determines the status if the filter element 120.

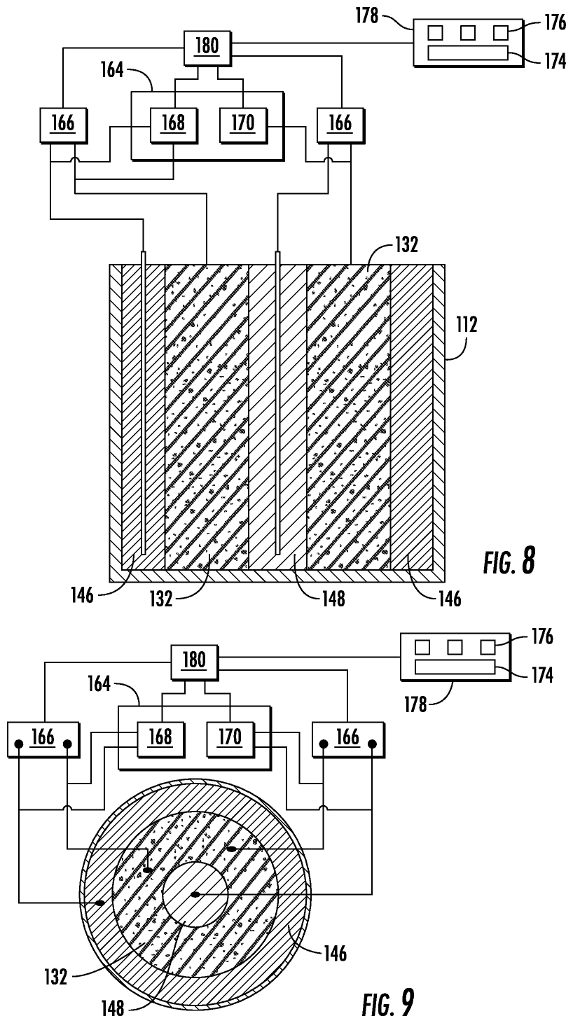

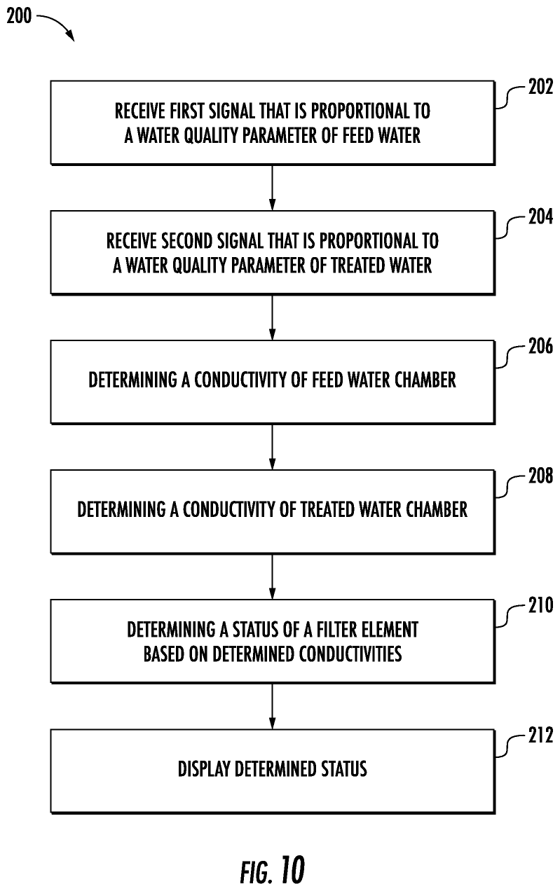

FIGS. 8 and 9 represent an embodiment in accordance with the present disclosure. As illustrated, first feed water electrode 154 is disposed in the feed water chamber 146 and first treated water electrode 158 is disposed in the treated water chamber 148. Second feed water electrode 156 and second treated water electrode 160 share a common electrode provided by the electrically conductive filter media 132. In some embodiments, the filter media 132 comprises carbon as a carbon block or granulated carbon, or powdered carbon with a binder. The filter media is in electrical communication with both the feed water chamber 146 and treated water chamber 148. Under some conditions, the carbon in the filter media 132 maintains predictable electrical properties allowing the power supply 166 and the sensing system, including first and second electrical measurement sensors 168, 170, to use the filter media 132 as a common electrode. The carbon-containing filter media may provide a conductive filter media that may be used as an electrode, for example the common electrode 132.

As in other embodiments, controller 180 drives the power supply 166 to provide a consistent and controlled voltage (or current), the first and second electrical measurement devices detect the resulting current (or voltage) and communicates the data to the controller 180. From the known controlled voltage (or current) and the detected current (or voltage), the controller 180 processes the electrical information and determines the status of the filter element 120.

Now that the construction of a water filter assembly in accordance with this disclosure has been presented, an exemplary method 200 of operation for internal performance monitoring for a water filter will be described with reference to FIG. 10. Method 200 begins at 202 at which the controller 180 receives a first signal proportional to a water quality parameter of the contents of the feed water chamber 146. The signal represents an electrical response of the contents of the feed water chamber 146 to a known electrical signal (voltage or current). The known electrical signal is provided to a treated water electrode and a common electrode in electrical communication with the feed water chamber 146 and the treated water chamber 148.

At 204, the controller 180 receives a second signal proportional to a water quality parameter of the contents of the treated water chamber. The signal represents an electrical response of the contents of the first treated water chamber 148 to a known electrical signal (voltage or current). The known electrical signal is provided to a treated water electrode and a common electrode in electrical communication with the feed water chamber 146 and the treated water chamber 148.

At 206, the controller 180 executes a series of preprogrammed steps to determine the conductivity of the contents of the feed water chamber 146. The controller drives the electrical power source 166 to produce a known electrical signal and receives a signal from the electrical measurement sensor 168. From this information, the conductivity at the feed water chamber 146 can be determined.

At 208, the controller 180 executes a series of preprogrammed steps to determine the conductivity of the contents of the treated water chamber 148. The controller 180 drives the electrical power source 166 to produce a known electrical signal and receives a signal from the electrical measurement sensor 170. From this information, the conductivity at the treated water chamber 148 can be determined.

At 210, the status of the filter element 120 is determined based on a manipulation of the determined conductivities. In one embodiment, the controller calculates the percentage change from the conductivity of the feed water to the conductivity of the treated water. The status is determined based on a specific predetermined threshold value. The threshold value may be, for example, a factory preset value determined empirically from laboratory or in-use test results or an offset value from the performance of a new filter element. In some embodiments, the threshold may be a user-created threshold or a field adjusted threshold, for example set by a technician. When the calculated or otherwise determined percentage change falls below the threshold, a status of filter fail is determined.

In another embodiment, the threshold is derived based on normal operating conditions during a time period of predetermined duration after an in-service event. The time period of predetermined duration after an in-service event being the initial in-service operation. For example, after a new filter is installed, the threshold is determined to be the difference between a mathematical representation of the present conductivity of the feed water and a mathematical representation of the conductivity of the treated water over the predetermined period. For example, the conductivity at a point in time (i.e., the present conductivity) may be compared to a mathematical representation (e.g. an average) over a period of time. The difference between the present conductivity and an average may be the present percent change in conductivity. The mathematical representation may be a mathematical average or a mathematical change of the feed water conductivity and the treated water conductivity. The threshold value could be the mathematical average, a mathematical change, or a different mathematical representation, offset by a value to allow for an acceptable decrease in filter performance. Once the threshold is determined, the controller continues to monitor the difference in conductivity between feed water and treated water. When the difference falls below the threshold, a status of filter fail is determined.

In another embodiment, the threshold is a dynamic threshold value determined by the controller based on the conductivity of the feed water, with different threshold values predetermined for ranges of feed water conductivity. Once the threshold is determined by the controller 180, the controller continues to monitor the conductivity for the feed water and the treated water. Therefore, a predetermined threshold value may change depending on the conductivity of the feed water. Either the percentage change scheme or the threshold scheme discussed above can be applied to the dynamic threshold value. This changing threshold (or dynamic threshold) value is predetermined for a plurality of ranges of conductivity of the content of the feed water chamber such that the predetermined threshold changes with each range of conductivity with a different threshold established for each range of conductivity. When the conductivity difference falls below the threshold, a status of filter fail is determined.

At 212, the controller signals the control panel causing the control panel 178 to provide an indicator of filter status as a signal, for example on the display 174 or otherwise signal the host appliance of the filter status.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A water filter assembly for a host appliance, the water filter assembly comprising:
a filter housing defining a filter chamber, a feed water inlet, and a treated water outlet;
a filter element received within the filter chamber defining a feed water chamber and a treated water chamber;
a feed water electrode disposed in the feed water chamber;
a treated water electrode disposed in the treated water chamber;
a common electrode in electrical communication with the feed water chamber and the treated water chamber;
an electric power supply in electrical communication with the feed water electrode, the treated water electrode, and the common electrode;
a sensing system electrically coupled to the feed water electrode, the treated water electrode, and the common electrode; and
a controller electrically coupled to the electric power supply and the sensing system, wherein the controller is configured to:
receive a first signal from sensing system that is proportional to a water quality parameter of a content of the feed water chamber;
receive a second signal from the sensing system that is proportional to a water quality parameter of a content of the treated water chamber; and
determine a filter status based on the first and second signals.

2. The water filter assembly of claim 1, wherein the controller drives the electric power supply to provide a first controlled voltage between the feed water electrode and the common electrode and a second controlled voltage between the treated water electrode and the common electrode.

3. The water filter assembly of claim 2, wherein the first controlled voltage and the second controlled voltage are different in at least one of magnitude and frequency.

4. The water filter assembly of claim 2, wherein the first signal is an electrical current proportional to a conductivity of the content of the feed water chamber.

5. The water filter assembly of claim 2, wherein the second signal is an electrical current proportional to a conductivity of the content of the treated water chamber.

6. The water filter assembly of claim 1, wherein the controller drives the electric power supply to provide a first controlled current to the feed water electrode and a second controlled current to the treated water electrode.

7. The water filter assembly of claim 6, wherein the first controlled current and the second controlled current are different from each other in at least one of magnitude and frequency.

8. The water filter assembly of claim 6, wherein the first signal is a voltage proportional to a conductivity of a content of the feed water chamber.

9. The water filter assembly of claim 6, wherein the second signal is a voltage proportional to a conductivity of a content of the treated water chamber.

10. The water filter assembly of claim 1, wherein:
the filter element comprises an electrically conductive filter media; and
the common electrode comprises the electrically conductive filter media.

11. The water filter assembly of claim 10, wherein the conductive filter media comprises one or more of carbon, activated carbon, and granulated carbon.

12. The water filter assembly of claim 1, wherein the controller is in operative communication with the host appliance.

13. The water filter assembly of claim 1, wherein the controller causes a display on a control panel to provide an indicator of a remaining useful life of the filter element based on the first signal and the second signal.

14. A method of operating a water filter assembly comprising a filter housing defining a filter chamber, a filter element received within the filter chamber defining a feed water chamber and a treated water chamber, a feed water electrode disposed in the feed water chamber, a treated water electrode disposed in the treated water chamber, a common electrode in electrical communication with the feed water chamber and the treated water chamber, an electric power supply in electrical communication with the feed water electrode, the treated water electrode, and the common electrode, a sensing system comprising a first electrical measurement sensor electrically coupled to the feed water electrode and the common electrode and a second electrical measurement sensor electrically coupled to the treated water electrode and the common electrode, and a controller electrically coupled to the electric power supply and the sensing system, the method comprising:
receiving at the controller a first signal from the first electrical measurement sensor that is proportional to a water quality parameter of a content of the feed water chamber;
receiving at the controller a second signal from the second electrical measurement sensor that is proportional to a water quality parameter of a content of the treated water chamber;
determining a conductivity of the content of the feed water chamber;
determining a conductivity of the content of the treated water chamber;
determining a status of the filter element based on the conductivity of the content of the feed water chamber and the conductivity of the content of the treated water chamber; and
displaying a status of the filter element on a display.

15. The method of claim 14, wherein determining the status of the filter element comprises:
calculating a mathematical change between the conductivity of the content of the feed water chamber and the conductivity of the content of the treated water chamber;
establishing a predetermined threshold value for the mathematical change between the conductivity of the content of the feed water chamber and the conductivity of the content of the treated water chamber; and
comparing the mathematical change to the predetermined threshold.

16. The method of claim 15, wherein:
the mathematical change is a percentage change; and
displaying the status comprises signaling a filter failure if the percentage change falls below the predetermined threshold.

17. The method of claim 16, wherein the predetermined threshold value is a dynamic threshold value depending on the determined conductivity of the content of the feed water chamber.

18. The method of claim 17, wherein the dynamic threshold value is predetermined for a plurality of ranges of conductivity of the content of the feed water chamber such that the predetermined threshold changes with each range of conductivity.

19. The method of claim 14, wherein, during a period of time of predetermined duration following an initial in-service operation, determining the status of the filter element comprises:
determining a mathematical representation of the conductivity of the content of the feed water chamber for the period of time;
determining a mathematical representation of the conductivity of the content of the treated water chamber for the period of time;
calculating a percentage change between the mathematical representation of the conductivity of the content of the feed water chamber and the mathematical representation of the conductivity of the content of the treated water chamber for the period of time;
establishing a threshold value based on the calculated percentage change for the period of time;
calculating a present conductivity of the content of the feed water chamber;
calculating a present conductivity of the content of the treated water chamber;
calculating a present percentage change between the present conductivity of the content of the feed water chamber and the present conductivity of the content of the treated water chamber;
comparing the present percent change to the established threshold for the period of time; and
displaying a status signaling a filter failure if the percentage change falls below the established threshold.

20. A water filter assembly for a host appliance, the water filter assembly comprising:
a filter housing defining a filter chamber, a feed water inlet, and a treated water outlet;
a filter element received within the filter chamber defining a feed water chamber and a treated water chamber;
a feed water sensor array disposed in the feed water chamber;
a treated water sensor array disposed in the treated water chamber;
an electric power supply in electrical communication with the feed water sensor array and the treated water sensor array;
a sensing system electrically coupled to the feed water sensor array and the treated water sensor array; and
a controller electrically coupled to the electric power supply and the sensing system, wherein the controller is configured to:
receive a first signal from the sensing system that is proportional to a water quality parameter of a content of the feed water chamber;
receive a second signal from the sensing system that is proportional to a water quality parameter of a content of the treated water chamber; and
determine a filter status based on the first and second signals.
